(19) United States
(12) Patent Application Publication
(10) Pub. No.: US 2021/0399576 A1
(43) Pub. Date: Dec. 23, 2021

(54) Method of maintaining a charge on a smart phone

(71) Applicant: Daryoosh Khashayar, San Diego, CA (US)

(72) Inventor: Daryoosh Khashayar, San Diego, CA (US)

(21) Appl. No.: 16/906,789

(22) Filed: Jun. 19, 2020

(51) Int. Cl. H02J 50/00; H02J 7/00

(52) U.S. Cl. CPC H02J 50/001; H02J 2310/22; H02J 7/00034

(57) ABSTRACT

The present invention is directed to a method of maintaining a charge on cell phones or smart phones. The phone to be charged is provided with a programmable circuit module or IC that senses the availability and strength of a WIFI or 5G signal. The module is capable of converting a WIFI, 5G, or other communication signal into a charging current. A user would have an application running on the phone, the application capable of allowing the user to interface with the module using the smartphone display. If several WIFI or 5G signals are sensed, the module will determine which signal is strongest, and begin drawing charging current from the signal and applying the signal to the phone. In an alternative embodiment, the module can convert all available WIFI and 5G signals into a charging current.

### FIELD OF THE INVENTION

The present invention relates generally to electrical charging systems. More particularly, the invention relates to a method of maintaining a charge on a smart phone.

### BACKGROUND OF THE INVENTION

Smart phones or cell phones have become ubiquitous in recent years. People rely on smart phones to manage nearly every aspect of their lives and thus the units are constantly in use. One noted problem therefore is that the phones, when used heavily, are constantly in need of recharging. While most users have charging access when at home, at the office, and in the car, it can be extremely difficult to find access to a charger when not in these areas. Even if access to AC power can be found, there is still the issue of having to carry around a cord. While some attempts to deal with this problem have been made, none completely solve the problem.

Some restaurants provide extra AC outlets to charge phones but the user must stay there in order to complete the charge cycle, which can take more than an hour.

Wireless chargers are known and eliminate the need to keep a charging cord necessary, but these are impractical for use by a restaurant or other “hot spot” because of cost and security concerns.

### SUMMARY OF THE INVENTION

The present invention is directed to a method of maintaining a charge on cell phones or smart phones. The phone to be charged is provided with a programmable circuit module or IC that senses the availability and strength of a WIFI or 5G signal. The module is capable of converting a WIFI, 5G, or other communication signal into a charging current. A user would have an application running on the phone, the application capable of allowing the user to interface with the module using the smartphone display.

If several WIFI or 5G signals are sensed, the module will determine which signal is strongest, and begin drawing charging current from the signal and applying the signal to the phone. In an alternative embodiment, the module can convert all available WIFI and 5G signals into a charging current.

It is a major object of the invention to provide an improved wireless charging system for smart phones.

It is another object of the invention to provide an improved wireless charging system for smart phones which is proximity based.

It is another object of the invention to provide an improved wireless charging system for smart phones that can select from a plurality of charging signals in a particular geographic area.

It is another object of the invention to provide an improved wireless charging system for smart phones which automatically initiates charging when the phone is within a predetermined distance of a charging source.

It is another object of the invention to provide an improved wireless charging system for smart phones where battery power is monitored.

It is another object of the invention to provide an improved wireless charging system for smart phones which uses a programmable module to convert a WIFI or 5G signal into a charging current.

### BRIEF DESCRIPTION OF THE DRAWINGS

FIG. 1 shows a diagrammatic overview of the system of the invention.

FIG. 2 shows a diagrammatic view of the interaction between a charger and a smart phone.

### DETAILED DESCRIPTION

The present invention is directed to a method and apparatus for a smart phone charging system. The system uses signals from 5G broadcast antennas and WIFI wireless routers as charging sources 20 to maintain a charge on a smartphone. In accordance with the inventive system, a smartphone 22 would have a programmable IC module 12 and a software application installed which would allow for automatically charging a smartphone 22 based on proximity to 5G broadcast antennas and WIFI transmitters.

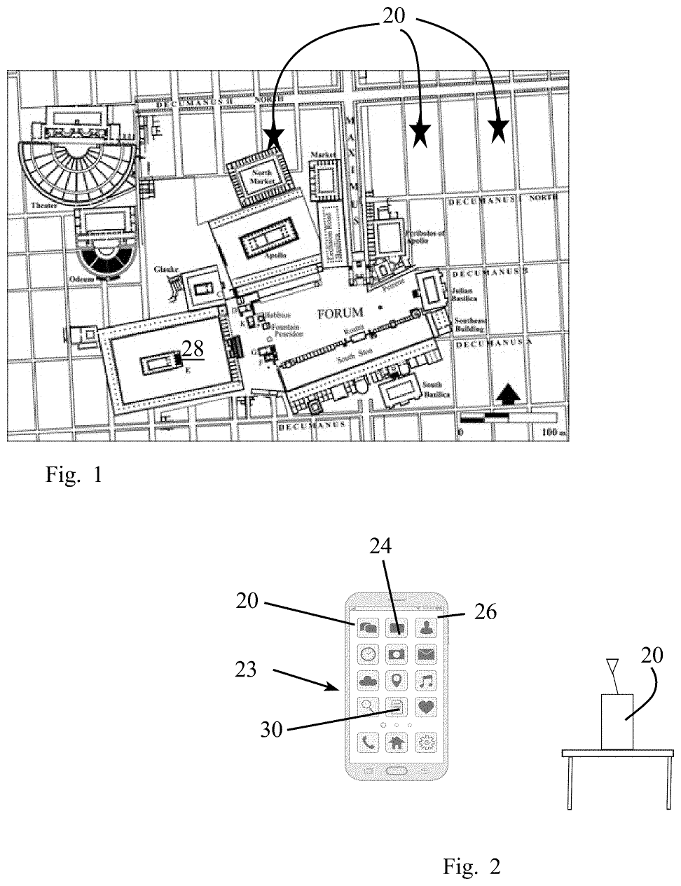

Referring now to FIGS. 1 and 2, the overall system is diagrammatically illustrated. The system is especially effective for use within population dense geographical areas as there are many potential charging sources 20. Thus, the system could be used in a downtown area, a large facility with many individual publicly accessible areas such as an office building or a mall, or any area where a number of wireless 5G cell towers or WIFI transmitters 20. The system is designed to maintain at least a trickle charge on a smartphone 22 as a user with the phone moves from one area to another. If there are enough charging sources 20 in an area, a user may never have to concern themselves with plugging in the phone 22 for charging. In accordance with one aspect of the invention, a business entity would install the module 12 after the phone 22 is manufactured, and charge usage based fees for charging services as will be explained in more detail. Of course, the IC 12 can be added to smartphone 22 at the time of manufacture, and a fee can be charged by, e.g., a cell phone service provider such as Sprint® to enable the module 12. Alternatively, the IC 12 can be inserted by a technician associated with a business entity for a one time fee, the business entity can be either a third party or the manufacturer of the phone 22. It can be appreciated that adding a “chip” other than a memory chip to a smartphone 22 is beyond the skill level of a typical lay person.

The smart phone 22 is a standard smart phone and may be based on either the Android, Iphone, or other platform. As discussed above, when IC 12 senses one or more WIFI or 5G signals it can determine the strongest signal and convert it to a charging current and apply the current to the phone battery 14. Alternatively and preferably, the IC 12 can convert several or all available WIFI or 5G signals present to provide a “combined” charging current. It should be noted that while WIFI and 5G signals are encrypted so that only subscribers can transmit and receive signals over the respective wireless networks, the energy generated by WIFI and 5G transmitters is accessible to any phone 22 within range as only the data is encrypted. The IC 12 is programmed with firmware to control its signal conversion function and its digital (operational) interface with phone 22. The software application, which is accessed by the user via GUI 24 which appears on the smart phone display 26, is used to generate an interactive menu to allow the user to interface with IC 12 and to effect charging in the method of the invention. Using the interactive menu the user can, inter alia, view all possible charging sources 20 in the immediate area (and their approximate locations using GPS), access data regarding the charging history of the phone, disable the IC 12, and check for firmware updates for the IC 12. Locations and types (WIFI or 5G) of known charging sources 20 will be downloaded to a user's phone from a central server 28 via e.g., the internet, the locations downloaded after the application is installed, the locations selected for downloading based on the current geographical position of the user.

As the signal strength from the charging source 20 is distance dependent, the charging rate will vary according to the distance of the user from the charger. To that end, the application stored on smart phone 22 will have a signal strength indicator in the form of a graphical display 30, the display 30 showing signal strength for all of the charging sources 20 available. The display 30 will also show the amount of time (or the rate of charge) needed to charge the phone 22 at the current distance given the number of charging sources 20 available. Alternatively and preferably, the IC 20 can receive and convert all signals within range and generate a combined charging current.

In operation, once the charging units 20 have been located within the target geographical area a user with a smart phone 22 may use the downloaded and installed application to map out the location and respective signal strength of chargers 20. When the user gets within charging proximity to a charger 20, the phone 22 will automatically begin charging. In the event the IC 12 can process multiple signals from charging units 20, the phone battery will be getting charged from all sources 20 at once. The installed application, via phone display, will show the number of chargers 20 currently accessed, and the amount of power available from each charger 20. The user may be notified by vibration, audibly, or visually of the fact that charging has been initiated. The charging rate for the present position of the smartphone 22, and the amount of time required for a full charge, the position of the chargers 20 from which charging power is accessed are all displayed using the application.

I claim:

1. A method of maintaining charge on one or more portable communication units having rechargeable batteries, said units operated in an area with WIFI or 5G transmitters present, comprising the steps of:
providing a charging module for each of said one or more portable communication units;
providing a software application for each of said communication units, said application capable of gathering and storing information on positioning of said charging units, said application also capable of allowing said charging signal to charge said batteries using said charging module; and,
automatically charging the batteries of any of said communication units when in proximity to one of said charging units.
